(19) United States
(12) Patent Application Publication
(10) Pub. No.: US 2023/0177974 A1
(43) Pub. Date: Jun. 8, 2023

(54) INFORMATION PROCESSING APPARATUS, INFORMATION PROCESSING METHOD AND STORAGE MEDIUM

(71) Applicant: CASIO COMPUTER CO., LTD., Tokyo (JP)

(72) Inventor: Asami ASO, Tokyo (JP)

(73) Assignee: CASIO COMPUTER CO., LTD., Tokyo (JP)

(21) Appl. No.: 17/983,039

(22) Filed: Nov. 8, 2022

(30) Foreign Application Priority Data
Dec. 7, 2021 (JP) 2021-198173
Apr. 18, 2022 (JP) 2022-067980

(51) Int. Cl. G09B 7/04; G09B 5/06

(52) U.S. Cl. CPC G09B 7/04; G09B 5/06

(57) ABSTRACT

An information processing apparatus includes at least one processor. The processor is configured to, based on question-giving history information on questions, identify, among users, a similar user who is similar to a target user among the users in proficiency tendency of the questions. The question-giving history information includes results of determination as to whether the users have correctly answered given questions that have been given to the users. The processor is further configured to derive a probability of the target user correctly answering a question as a deriving target question among the questions, based on a result of determination as to whether the similar user has correctly answered the deriving target question. The deriving target question is a question for which the probability is derived, and is a given question for the similar user. The processor is further configured to perform a specific process based on the derived probability.

### CROSS-REFERENCE TO RELATED APPLICATIONS

This application is based upon and claims the benefit of priority from Japanese Patent Application No. 2021-198173 filed on Dec. 7, 2021 and Japanese Patent Application No. 2022-067980 filed on Apr. 18, 2022, the entire contents of which are incorporated herein by reference.

### BACKGROUND

### Technical Field

The present disclosure relates to an information processing apparatus, an information processing method and a storage medium.

### Description of Related Art

Among terminal apparatuses usable for learning in various subjects, such as language, there is a terminal apparatus capable of carrying out tests (setting questions and determining whether answers are correct) in the subjects. Setting, on a test, a question(s) of a difficulty level appropriate for the learning level of a user makes it possible to judge the leaning level of the user appropriately and enhance the learning effect by the test itself.

As the method for setting a question of a difficulty level appropriate for the learning level of a user, there is a method for predicting the correct answer probability of a user correctly answering a question that has not been set for (given to) the user. For example, in JP 2020-521244 A, there is disclosed a technique of, on the basis of results of determination as to whether answers given by a user to questions are correct, analyzing the user's understanding of concepts included in the question(s) that have been given to the user, and on the basis of the analysis result, predicting the correct answer probability of the user for a question that has not been given to the user.

### SUMMARY

An information processing apparatus of the present disclosure includes at least one processor configured to

based on question-giving history information on a plurality of questions, identify, among users, a similar user who is similar to a target user among the users in proficiency tendency of the plurality of questions, wherein the question-giving history information includes correctness determination results of determination as to whether the users have correctly answered given questions that have been given to the users,

derive a correct answer probability of the target user correctly answering a question as a deriving target question among the plurality of questions, based on a correctness determination result of determination as to whether the similar user has correctly answered the deriving target question, wherein the deriving target question is a question for which the correct answer probability is derived, and is a given question for the similar user, and

perform a specific process based on the derived correct answer probability.

### BRIEF DESCRIPTION OF SEVERAL VIEWS OF DRAWING

The accompanying drawings, which are incorporated in and constitute a part of the specification, illustrate embodiments, and together with the general description given above and the detailed description of the embodiments given below, serve to explain the principles of the present disclosure, wherein:

FIG. 1 is a block diagram schematically showing configuration of a learning support system;

FIG. 2 is a block diagram showing functional configuration of a server;

FIG. 3 shows an example of contents of a user management DB;

FIG. 4 shows an example of contents of a dictionary DB;

FIG. 5 shows an example of contents of a learning history DB;

FIG. 6 is a block diagram showing functional configuration of a terminal apparatus;

FIG. 7 shows an example of a dictionary screen;

FIG. 8 shows an example of a difficulty specifying screen;

FIG. 9 shows a relationship between difficulty levels of word tests and correct answer probabilities for words to be selected;

FIG. 10 shows an example of a test screen;

FIG. 11 shows an example of contents of a test history DB;

FIG. 12 shows an example of contents of a correct answer probability DB;

FIG. 13 is a flowchart showing control procedure of a correct answer probability calculation process;

FIG. 14 is a flowchart showing control procedure of a test process;

FIG. 15 shows an example of feature vectors in a first modification;

FIG. 16 shows an example of the contents of the test history DB according to a second modification;

FIG. 17 shows an example of the contents of the learning history DB according to the second modification;

FIG. 18 is a flowchart showing the control procedure of the correct answer probability calculation process according to the second modification; and

FIG. 19 shows an example of the difficulty specifying screen according to the second modification.

### DETAILED DESCRIPTION

Hereinafter, one or more embodiments of the present disclosure will be described with reference to the drawings.

### <Configuration of Learning Support System>

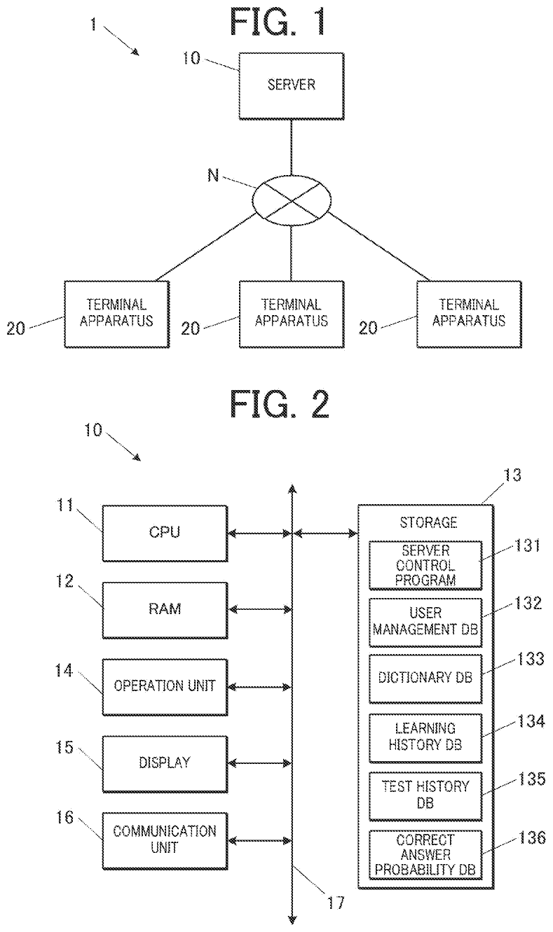

FIG. 1 is a block diagram schematically showing configuration of a learning support system 1 according to an embodiment(s).

The learning support system 1 (information processing system) includes a server 10 (information processing apparatus) and a plurality of terminal apparatuses 20 connected to the server 10 via a communication network N so that they can perform information communication with one another. The communication network N is, for example, the Internet, but not limited thereto and may be another network, such as a LAN (Local Area Network). At least part of the communication path between the server 10 and the terminal apparatuses 20 may be a wireless communication path.

The learning support system 1 provides a user who uses a terminal apparatus 20 with learning support service to support/assist language learning. The terminal apparatus 20 is, for example, a smartphone, but not limited thereto and may be a tablet terminal, a laptop PC (personal computer), a stationary PC or the like.

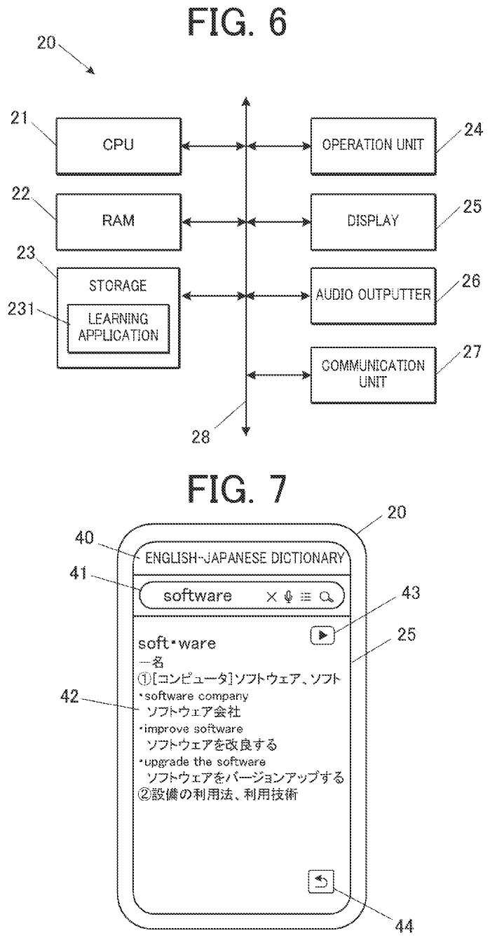

In the terminal apparatus 20, an application program for learning (hereinafter “learning application 231”, which is shown in FIG. 6) is installed. By executing the learning application 231, the terminal apparatus 20 provides the user with various types of service for language learning in cooperation with the server 10. For example, when receiving a search instruction for a word (headword or entry in a dictionary) from the user while executing the learning application 231, the terminal apparatus 20 obtains from the server 10 and displays entry information that includes meaning of the word, example sentences and/or the like. Further, while executing the learning application 231, the terminal apparatus 20 can carry out a word (vocabulary) test(s) to measure proficiency of words. The word test is, for example, a test on which spellings (letters/characters) of words are set as questions (which include problems, quizzes, etc.), and translations thereof should be put as answers, or a test on which translations of words are set as questions, and spellings thereof should be put as answers. In order to carry out a word test, the terminal apparatus 20 obtains a list of words to be on the word test and data of spellings and translations of the words from the server 10, sets the words as questions on the word test for (i.e., gives the words as questions to) the user, and when receiving answers to the questions from the user, determines whether the answers are correct and presents the results to the user.

The above are not limitations but examples of the service provided by the learning support system 1.

The learning support system 1 provides users who use terminal apparatuses 20 with the learning support service. The server 10 manages information on the usage state of the learning support service of each user, and provides each user with an appropriate type(s) of service in accordance with the information. For example, the server 10 analyzes test states of word tests of the users, and when carrying out a word test for a user, sets, on the word test, words as questions of a difficulty level appropriate for the learning level of the user on the basis of the analysis results. The method for determining the questions will be described later in detail.

### <Configuration of Server>

FIG. 2 is a block diagram showing functional configuration of the server 10.

The server 10 includes a CPU (Central Processing Unit) 11, a RAM (Random Access Memory) 12, a storage 13, an operation unit 14, a display 15, a communication unit 16 and a bus 17. The components of the server 10 are connected to one another via the bus 17.

The CPU 11 is a processor that controls operation of the server 10 by reading and executing a server control program 131 (program) stored in the storage 13, thereby performing various types of arithmetic processing. The server 10 may have a plurality of processors (e.g., a plurality of CPUs), and they may perform multiple processes that are performed by the CPU 11 in this embodiment. In this case, the processors may be involved in the same process(es) or independently perform different processes in parallel.

The storage 13 is a non-transitory storage medium storing the server control program 131 and various data so as to be readable by the CPU 11 as a computer. The storage 13 includes a nonvolatile memory, such as an HDD (Hard Disk Drive) or an SSD (Solid State Drive). The server control program 131 is stored in the storage 13 in the form of computer-readable program code. The data stored in the storage 13 includes a user management DB (database) 132 (feature information), a dictionary DB 133, a learning history DB 134, a test history DB 135 (question-giving history information) and a correct answer probability DB 136.

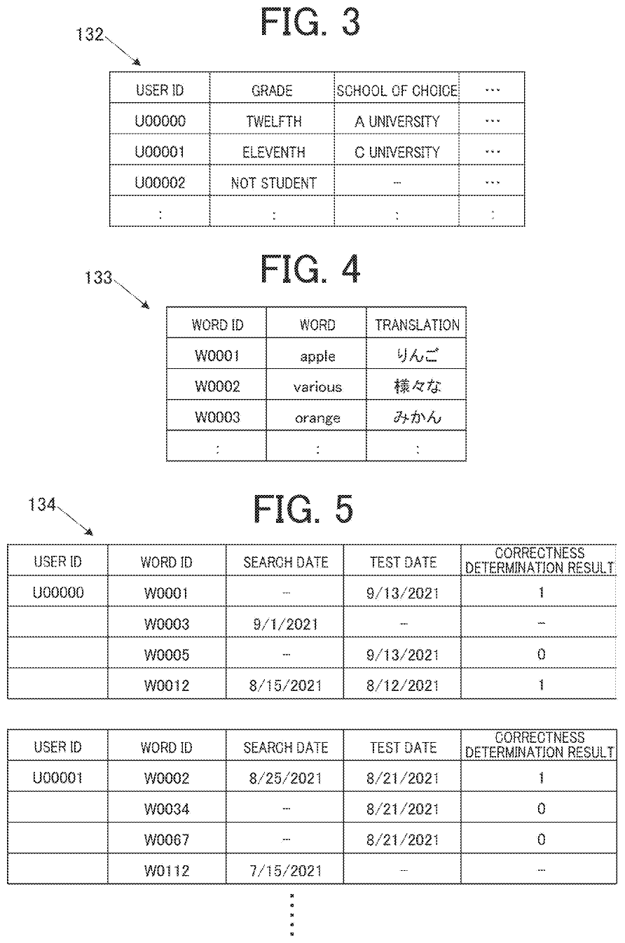

FIG. 3 shows an example of contents of the user management DB 132.

The user management DB 132 stores data on the users who use the learning support service. The user management DB 132 includes feature information on at least one (type) of the attribute(s) and the characteristic(s) of each user. One data row (record) in the user management DB 132 is for one user. In the example shown in FIG. 3, the user management DB 132 has data columns of “User ID”, “Grade” and “School of Choice”.

In the “User ID”, a unique code assigned to each user is registered.

In the “Grade”, the grade of the user is registered. If the user is not a student or pupil, data of “Not Student” is registered.

In the “School of Choice”, a school of choice input by the user beforehand is registered.

The user management DB 132 may further has data columns of other attributes (gender, age, etc.) and characteristics (study hours, study time slot, favorite category of words, etc.) of each user.

FIG. 4 shows an example of contents of the dictionary DB 133.

One data row (record) in the dictionary DB 133 is for one word (entry) in an English-Japanese dictionary. Information in one data row in the dictionary DB 133 corresponds to the abovementioned entry information on one entry. The dictionary DB 133 has data columns of “Word ID”, “Word” and “Translation”.

In the “Word ID”, a unique code assigned to each word (English word in this embodiment) is registered.

In the “Word”, the spelling of the word is registered.

In the “Translation”, the translation (Japanese translation/word in this embodiment) of the word is registered.

The dictionary DB 133 may further store data of dictionaries (English dictionary, etc.) in addition to the English-Japanese dictionary.

FIG. 5 shows an example of contents of the learning history DB 134.

The learning history DB 134 stores data of the learning history of each user in the learning support service. The learning history DB 134 has data blocks generated for the respective users. One data row (record) in one data block is for one word that a user corresponding to the data block has searched for and/or that has been on a word test(s) for the user. Each data block has data columns of “User ID”, “Word ID”, “Search Date”, “Test Date” and “Correctness Determination Result”.

In the “User ID”, a unique code assigned to each user and shared with the “User ID” in the user management DB 132 shown in FIG. 3 is registered.

In the “Word ID”, a unique code assigned to a word in each data row and shared with the “Word ID” in the dictionary DB 133 shown in FIG. 4 is registered.

In the “Search Date”, the last search date of the word in the data row is registered. In addition to the date, information on search time may be registered.

In the “Test Date”, the last test date of the word in the data row is registered. In addition to the date, information on test time may be registered.

In the “Correctness Determination Result”, the result of determination as to whether a user's answer to the word in the data row on a word test is correct is registered, wherein “1” indicates that the user's answer is correct, and “0” indicates that the user's answer is incorrect.

In the learning history DB 134 shown in FIG. 5, for example, the followings are registered; a user having a user ID of “U00000” gave a correct answer to a word having a word ID of “W0012” on a word test carried out on Aug. 12, 2021 (“8/12/2021”), and thereafter searched for the word on Aug. 15, 2021 (“8/15/2021”).

Examples of contents of the test history DB 135 and the correct answer probability DB 136 will be described later.

Referring back to FIG. 2, the operation unit 14 includes a pointing device, such as a mouse, and a keyboard, and receives positional input, key input and so forth made by its user and outputs operation information corresponding thereto to the CPU 11.

The display 15 includes a display device, such as a liquid crystal display, and performs various types of display on the display device in accordance with display control signals from the CPU 11.

The communication unit 16 includes, for example, a network card, and sends and receives data to and from the terminal apparatuses 20 on the communication network N in conformity with a predetermined communication standard.

### <Configuration of Terminal Apparatus>

FIG. 6 is a block diagram showing functional configuration of a terminal apparatus 20.

The terminal apparatus 20 includes a CPU 21, a RAM 22, a storage 23, an operation unit 24, a display 25, an audio outputter 26, a communication unit 27 and a bus 28. The components of the terminal apparatus 20 are connected to one another via the bus 28.

The CPU 21 is a processor that controls operation of the terminal apparatus 20 by reading and executing programs, such as the learning application 23, stored in the storage 23, thereby performing various types of arithmetic processing. The terminal apparatus 20 may have a plurality of processors (e.g., a plurality of CPUs), and they may perform multiple processes that are performed by the CPU 21 in this embodiment. In this case, the processors may be involved in the same process(es) or independently perform different processes in parallel.

The storage 23 is a non-transitory storage medium storing programs, such as the learning application 231, and various data so as to be readable by the CPU 21 as a computer. The storage 23 includes a nonvolatile memory, such as a flash memory. The programs are stored in the storage 23 in the form of computer-readable program code.

The operation unit 24 includes a touchscreen overlaid on the display screen of the display 25 and physical buttons, and receives touch operations on the touchscreen, press operations on the physical buttons and so forth made by its user and outputs operation information corresponding thereto to the CPU 21.

The display 25 includes a display device, such as a liquid crystal display, and performs various types of display on the display device in accordance with display control signals from the CPU 21.

The audio outputter 26 includes a speaker, and, for example, pronounces words, outputs audio of question sentences on tests and so forth in accordance with audio output control signals from the CPU 21. Further, the audio outputter 26 outputs audio signals to an external audio output device (e.g., earphone(s) or headphones) connected thereto with a cable or wirelessly, thereby causing the audio output device to output audio.

The communication unit 27 includes, for example, a communication module including an antenna, and sends and receives data to and from the server 10 on the communication network N in conformity with a predetermined communication standard.

### <Operation of Learning Support System>

Next, operation of the learning support system 1 will be described. Main components in the following operation (processes) are the CPU 11 of the server 10 and the CPU 21 of the terminal apparatus 20. However, for the sake of convenience, the server 10 and the terminal apparatus 20 may be described hereinafter as the main components therein.

A user who would like to receive the learning support service provided by the learning support system 1 executes the learning application 231 on his/her terminal apparatus 20 and logs in to the learning support system 1. The login to the learning support system 1 is performed, for example, by an authentication process of comparing a user ID and a password input by the user and sent from the terminal apparatus 20 to the server 10 with a user ID and a password registered in the server 10 beforehand. The user who logs in to the learning support system 1 can use and activate various functions of the learning support service on the learning application 231.

### <Word Search>

One of the basic functions of the learning support service provided by the learning support system 1 is word search in an English-Japanese dictionary. The user can cause the display 25 to display a dictionary screen 40 for word search in an English-Japanese dictionary by making a predetermined operation on the learning application 231.

FIG. 7 shows an example of the dictionary screen 40.

On the dictionary screen 40, a search box 41, an entry information display area 42, an audio play button 43 and a dictionary screen finish button 44 are displayed. The search box 41 is a box for specifying a search word. The entry information display area 42 is an area where retrieved entry information on the word is displayed. The audio play button 43 is a button for playing audio of the word. The dictionary screen finish button 44 is a button for finishing word search. When the spelling of a word that the user wants to search for is input in the search box 41 and search is performed, the terminal apparatus 20 requests entry information on the word from the server 10. In response to the request, the server 10 obtains the entry information on the specified word from the dictionary DB 133 and sends same to the terminal apparatus 20. The terminal apparatus 20 displays the obtained entry information in the entry information display area 42. Meanwhile, the server 10 registers the search date of the word in the data block in the learning history DB 134 for the user who searched for the word, thereby recording that the user has searched for the word.

### <Test>

The learning support service provided by the learning support system 1 offers word tests as described above. Hereinafter, as an example, a word test on which spellings of words are set as questions, and translations thereof should be put as answers will be described. In this embodiment, words to be on a word test (hereinafter “test words”) for the user of the terminal apparatus 20 are selected from words that the user has not searched for in the past and that have not been on word tests for the user in the past among the words included in the dictionary DB 133 as entries. The period of “the past” in this embodiment will be described later.

When the user makes an instruction to carry out a word test on the learning application 231, first, the display 25 displays a difficulty specifying screen 50 for specifying the difficulty of the word test.

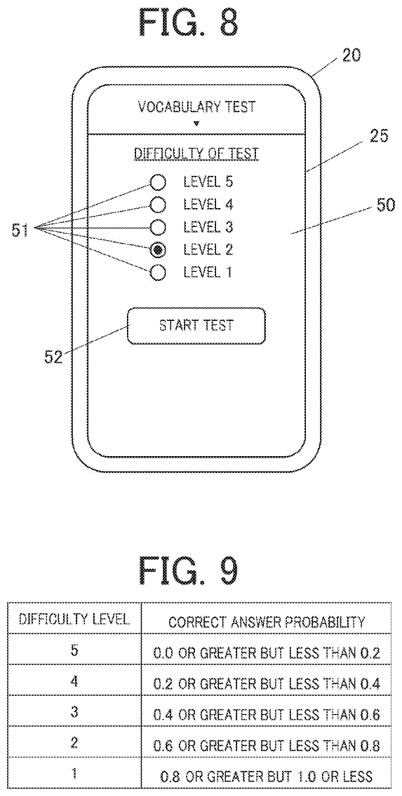

FIG. 8 shows an example of the difficulty specifying screen 50.

On the difficulty specifying screen 50, difficulty specifying buttons 51, a test start button 52 and so forth are displayed. The difficulty specifying buttons 51 are buttons for specifying the difficulty of a word test. The test start button 52 is a button for starting a word test. In this embodiment, with one of the difficulty specifying buttons 51, one of five difficulty levels can be specified. The five difficulty levels are from “Level 1” as the lowest difficulty level to “Level 5” as the highest difficulty level.

When one of the difficulty levels is specified with one of the difficulty specifying buttons 51 and an operation to select the test start button 52 is made, the terminal apparatus 20 requests a list of test words for the specified difficulty level (hereinafter “test word list”) from the server 10. In response to the request, the server 10 obtains test words for the specified difficulty level for the user from the dictionary DB 133 and generates a test word list. In the correct answer probability DB 136 in the storage 13 of the server 10, information on the correct answer probabilities of the user giving correct answers to the words that have not been on word tests for the user in the past and that the user has not searched for in the past is registered. On the basis of the correct answer probabilities, the server 10 extracts test words for the specified difficulty level. More specifically, as shown in FIG. 9, if the specified difficulty level is “Level 5”, the server 10 selects test words from words each having a correct answer probability of 0.0 or greater but less than 0.2; if the specified difficulty level is “Level 4”, the server 10 selects test words from words each having a correct answer probability of 0.2 or greater but less than 0.4; if the specified difficulty level is “Level 3”, the server 10 selects test words from words each having a correct answer probability of 0.4 or greater but less than 0.6; if the specified difficulty level is “Level 2”, the server 10 selects test words from words each having a correct answer probability of 0.6 or greater but less than 0.8; and if the specified difficulty level is “Level 1”, the server 10 selects test words from words each having a correct answer probability of 0.8 or greater but 1.0 or less. Thus, the server 10 performs the process of determining, on the basis of the correct answer probabilities of the user, questions to be given to the user among a plurality of questions (specific process).

The number of words to be included in a test word list, namely, the number of words to be on one word test, is predetermined by the settings and ten in this embodiment. The server 10 selects ten words each having a correct answer probability corresponding to the specified difficulty level, generates a test word list thereof, and sends it to the terminal apparatus 20. When obtaining the test word list, the terminal apparatus 20 changes a screen displayed by the display 25 to a test screen 60 for word tests.

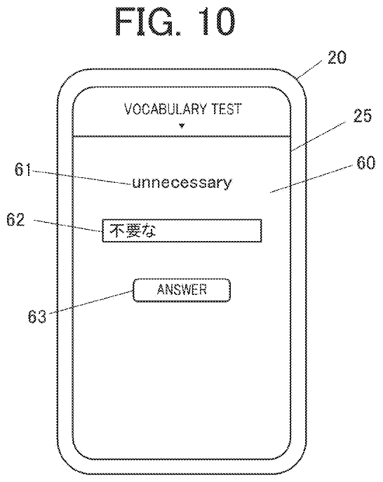

FIG. 10 shows an example of the test screen 60.

On the test screen 60, a test word 61, a text box 62 where a translation as an answer is input, an answer button 63 and so forth are displayed. The test word 61 is one of the words included in the test word list. The user can answer a question (test word 61) by inputting a translation of the test word 61 in the text box 62 and making an operation to select the answer button 63. When the user finishes giving an answer to one test word 61, the next test word 61 included in the test word list is displayed, so that the user can answer questions continuously. When the user finishes giving an answer to the last test word 61 of all the test words 61 (ten test words 61 in this embodiment), the correctness determination results of the answers to all the test words 61 are displayed on/by the display 25. Alternatively, each time the user finishes giving an answer to one test word 61, the correctness determination result of the answer to the test word 61 may be displayed.

The server 10 records the words, which the server 10 has included in the test word list, in the learning history DB 134 as words that have been given to the user as questions (given words/questions). That is, the server 10 adds, in the data block in the learning history DB 134 for the user who is taking (or took) the word test, data rows for the words included in the test word list, and registers the test date of the words therein. The server 10 also registers the correctness determination results of the answers to the words therein, thereby recording that the words have been given to the user as questions and also recording the correctness determination results.

### <Method for Calculating Correct Answer Probabilities>

Next, a method for calculating the correct answer probabilities will be described.

The server 10 performs, at a predetermined frequency (e.g., once a month), a correct answer probability calculation process for calculating the correct answer probabilities of all the users (users) for the words that have not been on word tests for the respective users (not-yet-given words/questions) and that the respective users have not searched for. In this embodiment, the words that have not been given to the respective users as questions and that the respective users have not searched for correspond to “deriving target questions”, for which the correct answer probabilities are calculated.

In the correct answer probability calculation process, the server 10 first collects test history data (question-giving history data) including (i) information on whether each of all the words registered in the dictionary DB 133 (i.e., all questions (a plurality of questions) settable on word tests) has been given to each user as a question and (ii) the correctness determination results of each user's answers to given words, and registers the collected data in the test history DB 135. As the correctness determination results of each user's answers to the given words, those at word tests carried out within a predetermined period gone back from the present point in time (hereinafter “last predetermined period”, e.g., the last three months) are collected. If a word as a question has been given to a user multiple times within the predetermined period, the correctness determination result of the last time the word was given to the user is used (collected).

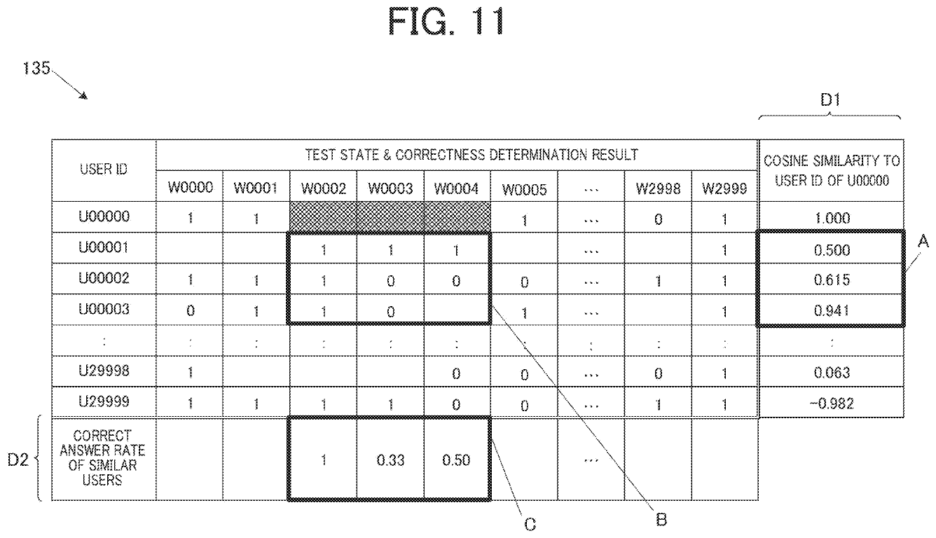

FIG. 11 shows an example of contents of the test history DB 135.

One data row (record) in the test history DB 135 is for one user. The test history DB 135 has the number of data rows corresponding to the total number of users (30,000 users having user IDs of U00000 to U29999 in this embodiment).

One data column in the test history DB 135 is for one word. The test history DB 135 has the number of data columns corresponding to the total number of words (3,000 words having word IDs of W0000 to W2999 in this embodiment) registered in the dictionary DB 133.

Data for each word in each data row is “0”, “1” or “null (no data)”.

The “0” indicates that the word as a question has been given to a user corresponding to the data row at least once within the last predetermined period, and the correctness determination result of the last time the word was given to the user is “incorrect”.

The “1” indicates that the word as a question has been given to a user corresponding to the data row at least once within the last predetermined period, and the correctness determination result of the last time the word was given to the user is “correct”.

The “null” indicates that the word as a question has not been given to a user corresponding to the data row within the last predetermined period.

Thus, the test history DB 135 includes information on the test states of all the words of all the users (i.e., whether each word as a question has been given to each user) and information on the correctness determination results of each user's answers to given words.

Next, on the basis of the test states and the correctness determination results (in a data column of “Test State & Correctness Determination Result”) in the test history DB 135, the server 10 identifies, for each of the users as a target user, similar users who are similar to the target user in proficiency tendency of words among the users except the target user. In this embodiment, collaborative filtering is used therefor.

More specifically, first, feature vectors are identified for a user as the target user, for whom similar users are identified, and each of the other users (hereinafter “comparable users”). The feature vectors are vectors including, among data for all the words (data on 3,000 words in FIG. 11) in the data rows in the test history DB 135, data of the target user and a comparable user for given words to both the target user and the comparable user (i.e., words for which values in the data rows for the target user and the comparable user are “0” or “1”) as elements. In this embodiment, feature vectors are vectors composed of such elements.

A case will be described in which the total number of words is ten, and data of the target user and a comparable user for these words are as follows, wherein “—” represents “null”.

Target User: 01——01110—

Comparable User: 101——01—1—

In this case, data for the 1^{st}, 2^{nd}, 6^{th}, 7^{th} and 9^{th} words starting from the left, which are given words to both the target user and the comparable user, are the elements of their feature vectors, so that a feature vector a of the target user and a feature vector b of the comparable user are identified as follows.

Feature Vector a=(0, 1, 1, 1, 0)

Feature Vector b=(1, 0, 0, 1, 1)

Next, cosine similarity between the feature vectors of the target user and the comparable user is calculated using the following formula.

$$cos ( \vec{a} , \vec{b} ) = \frac{\vec{α} \cdot \vec{b}}{\vert \vec{a} \vert \vert \vec{b} \vert} = \frac{{\sum }_{1}^{n} {a}_{i} {b}_{i}}{\sqrt{{\sum }_{1}^{n} {a}_{i}^{2}} \sqrt{{\sum }_{1}^{n} {b}_{i}^{2}}} \qquad [ Formula 1 ]$$

The closer the cosine similarity is to “1”, the more similar the comparable user is to the target user in feature (proficiency tendency of words in this embodiment). This cosine similarity is calculated between the target user and each of the other users, namely, the comparable users. A data group D1 in FIG. 11 shows calculation results of the cosine similarity between a user having a user ID of “U00000” as the target user and each of the comparable users.

Depending on the number of words for which at least data of one of two users is “null”, the number of dimensions of their feature vectors may be too small to compare their proficiency tendencies with a desired degree of accuracy using the cosine similarity. Hence, a user whose feature vector has less than a predetermined number of dimensions in relation to the target user may be excluded from a list of users from which similar users to the target user are extracted.

On the basis of the calculated cosine similarities of the data group D1, similar users who are similar to the target user in proficiency tendency of words are identified.

For example, among the comparable users, users each having a cosine similarity of a reference value or greater (e.g., 0.5 or greater) may be identified as similar users to the target user.

Alternatively, among the comparable users, a predetermined reference number of users selected in descending order of the cosine similarity (e.g., top ten users) may be identified as similar users to the target user.

Still alternatively, among the comparable users, a predetermined reference proportion of users selected in descending order of the cosine similarity (e.g., users in the top 5%) may be identified as similar users to the target user.

In the case of FIG. 11, it is predetermined that three comparable users selected in descending order of the cosine similarity are identified as similar users, and three users having user IDs of “U00001”, “U00002” and “U00003” (their cosine similarities are shown in an area A) are identified as similar users to the target user.

Next, for not-yet-given words to the target user (shaded cells in FIG. 11, i.e., three words having word IDs of “W0002”, “W0003” and “W0004”), the correct answer probabilities of the target user (shown in an area C in FIG. 11) are calculated (derived) on the basis of the data of the correctness determination results of the similar users' answers thereto (shown in an area B in FIG. 11). More specifically, for each not-yet-given word to the target user, the correct answer rate (average of the correctness determination results) of the identified similar users is treated as the correct answer probability of the target user. For example, to the word having a word ID of “W0002” in FIG. 11, all of the three similar users have given a correct answer (correctness determination result of “1”), so that the correct answer probability of the target user therefor is calculated as “1”. Also, to the word having a word ID of “W0003” in FIG. 11, among the three similar users, one has given a correct answer (correctness determination result of “1”), and the other two have given an incorrect answer(s) (correctness determination result of “0”), so that the correct answer probability of the target user therefor is calculated as “0.33”. Also, to the word having a word ID of “W0004” in FIG. 11, among the three similar users, one has given a correct answer (correctness determination result of “1”), another one has given an incorrect answer (correctness determination result of “0”), and the other one has not been given the word (no correctness determination result, i.e., “null”), so that the correct answer probability of the target user therefor is calculated as “0.50”.

Thus, a data group D2 composed of the correct answer probabilities of the target user for all the not-yet-given words to the target user is generated.

As described above, in this embodiment, the words that have not been given to the target user as questions but that the target user has searched for are not eligible as test words for the target user, and hence the correct answer probabilities of the target user for the words that the target user has searched for (retrieved words) are set to “null”. Thus, in this embodiment, among not-yet-given words, the words that the target user has not searched for correspond to “deriving target questions”. However, this is not a limitation, and not-yet-given words may be eligible as test words no matter whether they are retrieved words or not. In this case, regardless of whether they are retrieved words or not, not-yet-given words are set as deriving target questions, and the correct answer probabilities of the target user therefor are calculated and registered in the data group D2.

The data group D1 and the data group D2 generated in the process of deriving the correct answer probabilities may be included in the test history DB 135, or may be stored not in the test history DB 135 but in another storage area of the storage 13.

Thereafter, with each of the remaining users as the target user, similar users are identified for the target user and the correct answer probabilities are derived in the same manner as the above. The data group D2 composed of the correct answer probabilities of each user as the target user is registered in the correct answer probability DB 136.

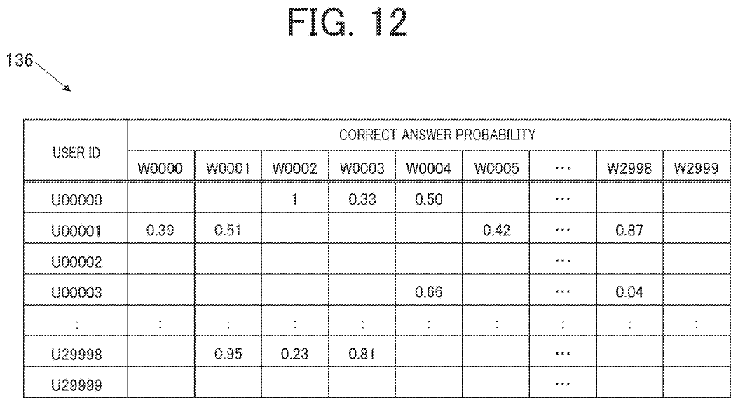

FIG. 12 shows an example of contents of the correct answer probability DB 136.

One data row in the correct answer probability DB 136 is for one user, and in data columns for the respective words, the correct answer probabilities of each user for the respective words (e.g., values of the data group D2 in FIG. 11), each user corresponding to each data row, are registered. For given words to and retrieved words by each user corresponding to each data row, the correct answer probabilities are set to “null”. The correct answer probabilities in the correct answer probability DB 136 are, as described above, used in the process of selecting words each having a correct answer probability corresponding to the specified difficulty level.

### <Control Procedure of Correct Answer Probability Calculation Process>

Next, the control procedure of the correct answer probability calculation process for calculating the correct answer probabilities will be described.

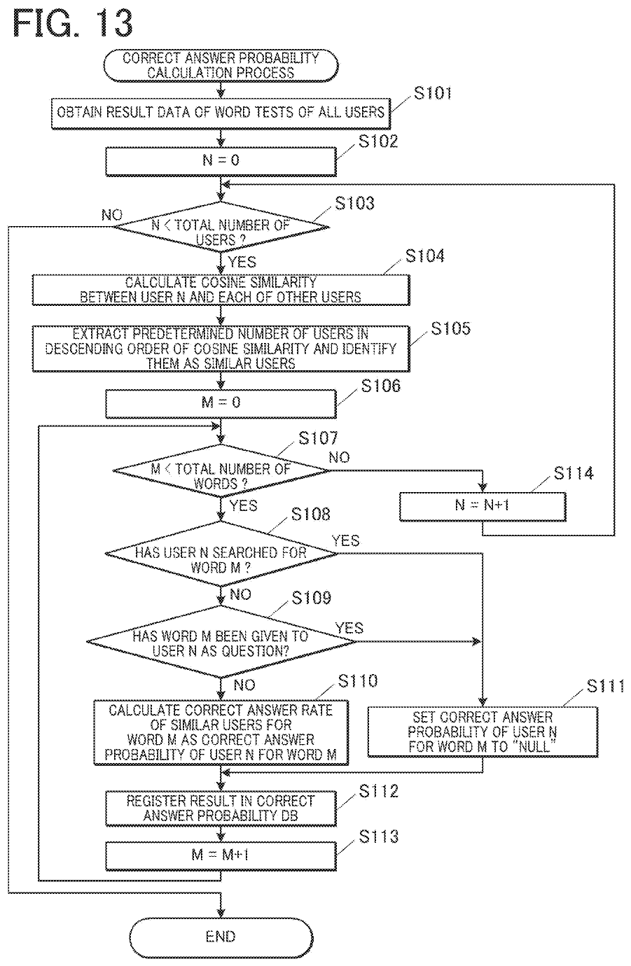

FIG. 13 is a flowchart showing the control procedure of the correct answer probability calculation process.

As described above, the correct answer probability calculation process is performed at a predetermined frequency, for example, once a month.

When the correct answer probability calculation process is started, the CPU 11 of the server 10 obtains result data of word tests of all the users (Step S101). In this embodiment, the CPU 11 obtains, from the data blocks for the respective users in the learning history DB 134, given words and the correctness determination results about the words, and registers their contents in the test history DB 135.

The CPU 11 assigns “0” to a variable N representing the ordinal number of a user (Step S102). Hereinafter, the N^{th} user (N is from 0 to 29,999 in this embodiment) is referred to as “user N”.

The CPU 11 determines whether the variable N is less than the total number of users (Step S103). If the CPU 11 determines that the variable N is less than the total number of users (Step S103; YES), the CPU 11 calculates the cosine similarity between the user N (target user) and each of the other users (comparable users) and generates the data group D1 shown in FIG. 11 (Step S104).

The CPU 11 extracts a predetermined reference number of users in descending order of the cosine similarity and identifies them as similar users to the user N (Step S105). As described above, the method for identifying the similar users based on the cosine similarity(ies) is not limited to this.

The CPU 11 assigns “0” to a variable M representing the ordinal number of a word (Step S106). Hereinafter, the M^{th} word (M is from 0 to 2,999 in this embodiment) is referred to as “word M”.

The CPU 11 determines whether the variable M is less than the total number of words (Step S107). If the CPU 11 determines that the variable M is less than the total number of words (Step S107; YES), the CPU 11 determines whether the user N has searched for the word M (Step S108). In Step S108, the CPU 11 determines that the user N has searched for the word M if a search date is registered in the data row for the word M in the data block for the user N in the learning history DB 134.

If the CPU 11 determines that the user N has not searched for the word M (Step S108; NO), the CPU 11 determines whether the word M has been given to the user N as a question (Step S109). In Step S109, the CPU 11 determines that the word M has been given to the user N as a question if a test date is registered in the date row for the word M in the data block for the user N in the learning history DB 134.

If the CPU 11 determines that the word M has not been given to the user N (Step S109; NO), the CPU 11 calculates the correct answer rate of the similar users for the word M as the correct answer probability of the user N for the word M (Step S110).

If the CPU 11 determines in Step S108 that the user N has searched for the word M (Step S108; YES) or determines in Step S109 that the word M has been given to the user as a question (Step S109; YES), the CPU 11 sets the correct answer probability of the user N for the word M to “null” (Step S111).

In the case where retrieved words among not-yet-given words are also eligible as test words, Step S108 is omitted.

After Step S110 or Step S111, the CPU 11 registers the calculation result (which includes “null”) of the correct answer probability in the correct answer probability DB 136 (Step S112).

The CPU 11 adds “1” to the variable M (Step S113) and returns to Step S107. If the CPU 11 determines in Step S107 that the variable M has reached the total number of words (Step S107; NO), the CPU 11 adds “1” to the variable N (Step S114) and returns to Step S103. If the CPU 11 determines in Step S103 that the variable N has reached the total number of users (Step S103; NO), the CPU 11 ends the correct answer probability calculation process.

### <Control Procedure of Test Process>

Next, the control procedure of a test process for a word test will be described.

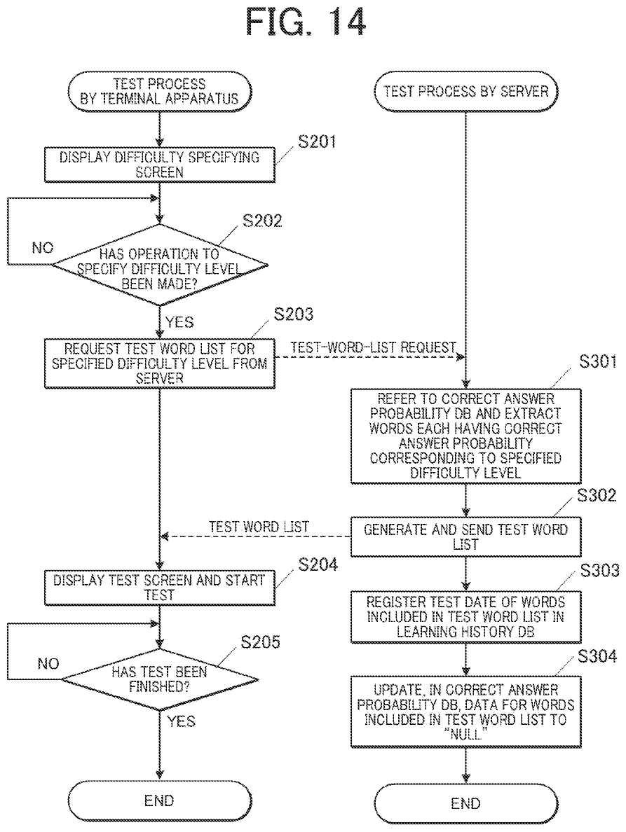

FIG. 14 is a flowchart showing the control procedure of the test process.

FIG. 14 shows part of the test process that is performed by the CPU 21 of the terminal apparatus 20 and part of the test process that is performed by the CPU 11 of the server 10 together.

When the test process is started, the CPU 21 of the terminal apparatus 20 causes the display 25 to display the difficulty specifying screen 50 (Step S201).

The CPU 21 determines whether an operation to specify a difficulty level (operation to select the test start button 52 in FIG. 8 with one of the difficulty specifying buttons 51 in FIG. 8 selected) has been made (Step S202). If the CPU 21 determines that no such an operation has been made (Step S202; NO), the CPU 21 repeats Step S202. If the CPU 21 determines that an operation to specify a difficulty level has been made (Step S202; YES), the CPU 21 requests a test word list for the specified difficulty level from the server 10 (Step S203). In Step S203, the CPU 21 sends a request signal for the test word list to the server 10.

When receiving the request signal for the test word list, the CPU 11 of the server 10 refers to the data row for the user who is going to take a word test (target user) in the correct answer probability DB 136 and extracts words each having a correct answer probability corresponding to the specified difficulty level (shown in FIG. 9) (Step S301). The CPU 11 generates data of the test word list that includes data of spellings and translations of a predetermined number of words (ten words in this embodiment) among the extracted words and sends same to the terminal apparatus 20 (Step S302).

When receiving the test word list, the CPU 21 of the terminal apparatus 20 causes the display 25 to display the test screen 60 and starts a word test (Step S204). In Step S204, the CPU 21 causes the display 25 to display one of the words included in the test word list on the test screen 60, receives an answer that is a translation input in the text box 62 by the user, and, when the answer button 63 is selected with the translation input in the text box 62, compares the input translation with translation data of the word included in the test word list, thereby determining whether the answer is correct. The CPU 21 performs this process for each of all the words included in the test word list. When the user has given answers to all the words, the CPU 21 causes the display 25 to display the correctness determination results about all the words.

The CPU 21 determines whether the user has finished the word test (i.e., whether the correctness determination results have been displayed) (Step S205). If the CPU 21 determines that the user has not finished the word test yet (Step S205; NO), the CPU 21 repeats Step S205. If the CPU 21 determines that the user has finished the word test (Step S205; YES), the CPU 21 ends its part of the test process.

Meanwhile, the CPU 11 of the server 10 registers the test date of the words included in the test word list, which the server 10 has sent to the terminal apparatus 20 in Step S302, in the learning history DB 134 (Step S303). This records that the words have been given to the user as questions. Further, the CPU 11 changes the data for the words included in the test word list in the data row for the user, who is taking a word test, in the correct answer probability DB 136 to “null” (Step S304). Thus, the words as given words to the user are not extracted as test words for the user from the next time the user takes a word test.

After Step S304, the CPU 11 ends its part of the test process.

### <First Modification>

Next, a first modification of the above embodiment will be described. The first modification is the same as the above embodiment except for the method for identifying the similar users. Hereinafter, different points from the above embodiment will be described.

In the above embodiment, the correctness determination results of the answers to given words in the test history DB 135 (question-giving history information) are used for the feature vectors of the target user and each of the comparable users to calculate the cosine similarity therebetween to identify the similar users. Meanwhile, in this modification, the correctness determination results in the test history DB 135 and the feature information on at least one (type) of the attribute(s) and the characteristic(s) of each user in the user management DB 132 (feature information) are used for the feature vectors of the target user and each of the comparable users to calculate the cosine similarity therebetween to identify the similar users.

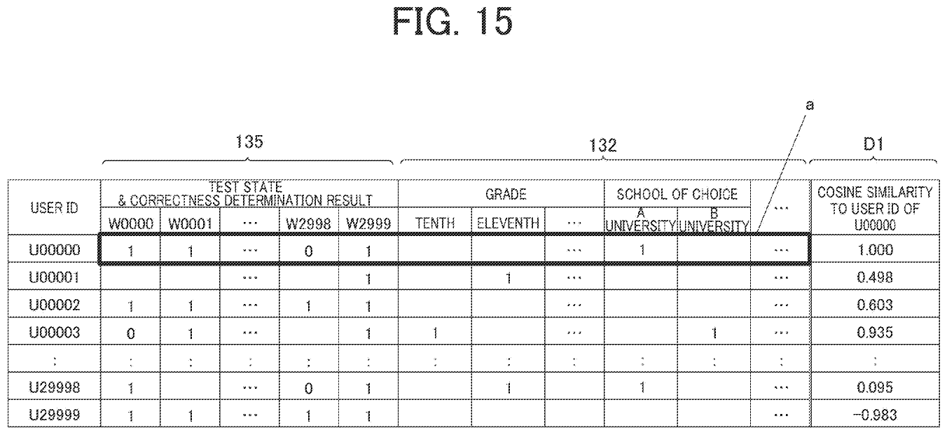

FIG. 15 shows an example of the feature vectors in the first modification.

In FIG. 15, a data row for each user has, in addition to the contents of the test history DB 135, the data columns of the “Grade” and the “School of Choice” in the user management DB 132. More specifically, as to the “Grade”, data columns for sections such as “Tenth” and “Eleventh” are added, and as to the “School of Choice”, data columns for sections such as “A University” and “B University” are added. Then, in a data column(s) for a section(s) under which each user falls, “1” is registered, whereas in a data column(s) for a section(s) under which each user does not fall, “null” is registered. In this modification, as the feature vector of the target user, a feature vector a is used, the feature vector a including data in the test history DB 135 and data in the user management DB 132 as elements. As to elements corresponding to the sections of the “Grade” and the “School of Choice”, only the section(s) in which “1” is registered for both the target user and a comparable user are used as elements of their feature vectors, and accordingly the section(s) in which “null” is registered for at least one of the target user and the comparable user are not used as elements of their feature vectors. This method makes a comparable user who agrees with the target user in the sections of the “Grade” and the “School of Choice”, namely, who shares the attributes and the characteristics with the target user, have a greater cosine similarity to the target user and be likely to be identified as a similar user to the target user.

The feature information on users may be used to identify similar users to the target user without being incorporated into the elements of the feature vectors.

For example, after calculation of the cosine similarity between the target user and each comparable user using their feature vectors composed of only the correctness determination results in the test history DB 135 as elements, correction may be made to increase the cosine similarity according to the level of the concordance rate between the feature information on the target user and the feature information on each comparable user.

Further, a user whose feature information has a concordance rate of a predetermined value or less in relation to the target user's feature information may be excluded from the list of users from which similar users to the target user are extracted.

### <Second Modification>

Next, a second modification of the above embodiment will be described.

In the above embodiment, test words for the target user are determined from the words that have not been given to the target user as questions (not-yet-given words) (and that the target user has not searched for) in accordance with their correct answer probabilities. However, it may be significant or beneficial to again give words that have been given to the target user as questions (given words/questions) but to which the target user has given incorrect answers (incorrectly-answered words/questions) to the target user as questions. This is because giving such words as questions again can check the learning effect and fix the learned matters in user's memory.

Hence, in this modification, not only not-yet-given words (not-yet-given questions) but also the words that have been given to the target user as questions (given questions) but to which the target user has given incorrect answers (incorrectly-answered questions) are set as deriving target questions, and the correct answer probabilities of the target user therefor are calculated. Then, questions to be given to the target user (test words) are determined/selected from the deriving target questions, which include not-yet-given questions and incorrectly-answered questions, in accordance with their correct answer probabilities. Further, in this modification, the words that the target user has searched for in the past (retrieved words) are also eligible as test words. This is because the words as incorrectly-answered questions are often retrieved to learn after they are on word tests. However, this is not a limitation, and in this modification too, the words that the target user has searched for in the past may be ineligible as test words.

The other points are the same as those in the above embodiment. Hereinafter, the different points from the above embodiment will be described in detail. The second modification may be combined with the first modification as appropriate.

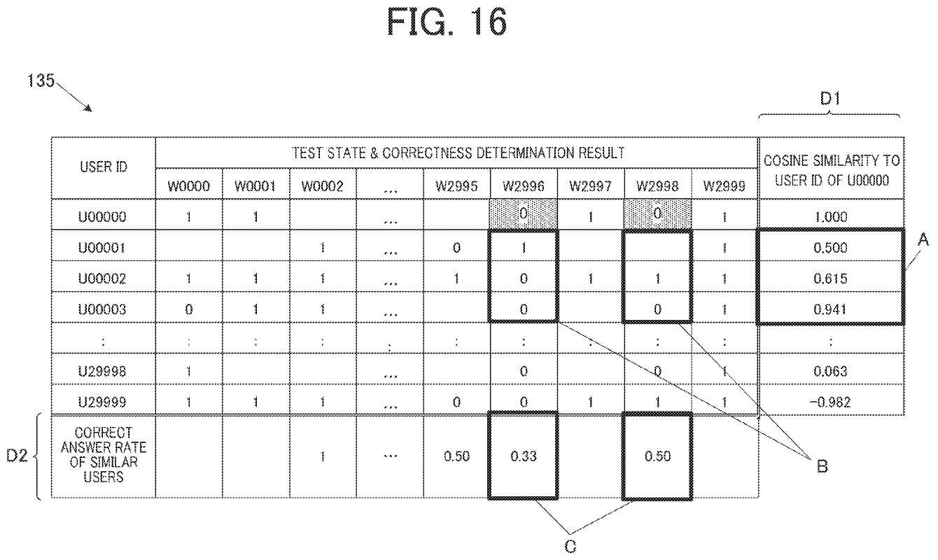

FIG. 16 shows an example of contents of the test history DB 135 according to the second modification.

In this modification too, the target user is the user having a user ID of “U00000”. As in the above embodiment, similar users to the target user are the three users having user IDs of “U00001”, “U00002” and “U00003” (their cosine similarities are shown in an area A in FIG. 16). For not-yet-given words to the target user (words having word IDs of “W0002” and “W2995” in FIG. 16), the correct answer probabilities of the target user are calculated in the same manner as in the above embodiment.

In this modification, the correct answer probabilities of the target user are calculated for the words that have been given to the target user as questions in the past but to which the target user has given incorrect answers (i.e., words each having a correctness determination result of “0”; words having word IDs of “W2996” and “W2998” in FIG. 16) too. For such incorrectly-answered questions too, the correct answer probabilities of the target user (shown in areas C in FIG. 16) are calculated (derived) on the basis of the data of the correctness determination results of the similar users' answers thereto (shown in areas B in FIG. 16). That is, for each incorrectly-answered question, the correct answer rate (average of the correctness determination results) of the similar users is treated as the correct answer probability of the target user. More specifically, to the word having a word ID of “W2996”, among the three similar users, one has given a correct answer (correctness determination result of “1”), and the other two have given an incorrect answer(s) (correctness determination result of “0”), so that the correct answer probability of the target user therefor is calculated as “0.33”. Also, to the word having a word ID of “W2998”, among the three similar users, one has given a correct answer (correctness determination result of “1”), another one has given an incorrect answer (correctness determination result of “0”), and the other one has not been given the word (no correctness determination result, i.e., “null”), so that the correct answer probability of the target user therefor is calculated as “0.50”.

In the case where the correct answer probability of the target user is derived for each incorrectly-answered question, the correct answer rate of the similar users and the target user may be used as the correct answer probability of the target user, instead of the correct answer rate of the similar users only. In this case, as shown in FIG. 16, to the word having a word ID of “W2996”, among the four users, which are the three similar users and the target user, one has given a correct answer (correctness determination result of “1”), and the other three have given an incorrect answer(s) (correctness determination result of “0”), so that the correct answer probability of the target user therefor is calculated as “0.25”. Also, to the word having a word ID of “W2998”, among the four users, one has given a correct answer (correctness determination result of “1”), other two have given an incorrect answer(s) (correctness determination result of “0”), and the other one has not been given the word (no correctness determination result, i.e., “null”), so that the correct answer probability of the target user therefor is calculated as “0.33”.

In this modification too, the correct answer probabilities of each of all the users are calculated for the respective deriving target questions (not-yet-given questions and incorrectly-answered questions). In this modification, the calculated correct answer probabilities of each user are registered in the learning history DB 134.

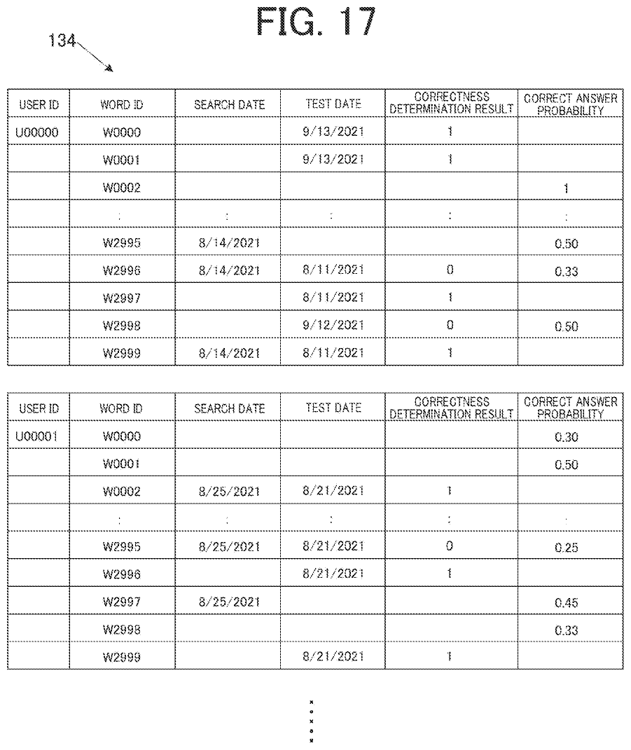

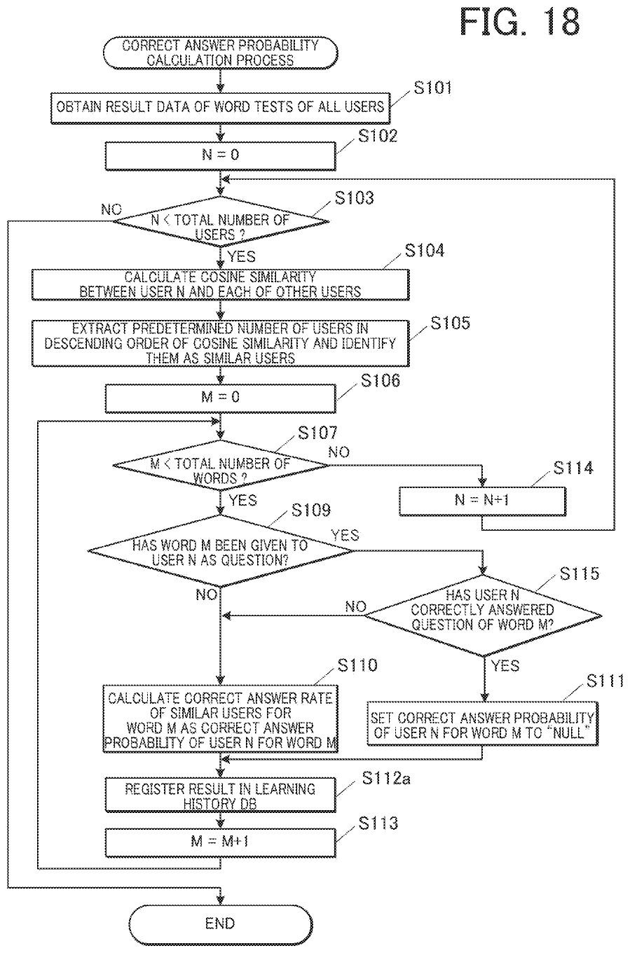

FIG. 17 shows an example of contents of the learning history DB 134 according to the second modification.

The learning history DB 134 shown in FIG. 17 has data blocks for the respective users. Each data block has data rows (records) for the respective words. Each data block has a data column of the “Correct Answer Probability”, and the calculated correct answer probabilities are registered in this data column. Referring to the learning history DB 134 shown in FIG. 17 makes it possible to obtain the correct answer probabilities for not-yet-given questions and the correct answer probabilities for incorrectly-answered questions separately. More specifically, the correct answer probabilities in data rows where “null” (no data) is registered in data columns of the “Test Date” and the “Correctness Determination Result” can be determined as the correct answer probabilities for not-yet-given questions, whereas the correct answer probabilities in data rows where “0” (incorrect) is registered in the data column of the “Correctness Determination Result” can be determined as the correct answer probabilities for incorrectly-answered questions. The correct answer probabilities are not calculated for words for which “1” (correct) is registered in the data column of the “Correctness Determination Result”.

As in the above embodiment, the correct answer probabilities may be registered in the correct answer probability DB 136, instead of the learning history DB 134. In this case, for example, a first database where only the correct answer probabilities of each user for not-yet-given words are registered (the same database as the correct answer probability DB 136 shown in FIG. 12) and a second database where only the correct answer probabilities of each user for incorrectly-answered questions are registered may be generated separately. This makes it possible to register the correct answer probabilities for not-yet-given questions and the correct answer probabilities for incorrectly-answered questions in a distinguishable manner.

Next, the control procedure of the correct answer probability calculation process in the second modification will be described.

FIG. 18 is a flowchart showing the control procedure of the correct answer probability calculation process according to the second modification.

FIG. 18 is the same as FIG. 13, each showing the flowchart of the correct answer probability calculation process, except that Step S108 is deleted, Step S115 is added, and Step S112 is replaced by Step S112a.

Steps S101 to S107 in FIG. 18 are the same as Steps S101 to S107 in FIG. 13, respectively. If the CPU 11 determines in Step S107 that the variable M is less than the total number of words (Step S107; YES), the CPU 11 determines whether the word M has been given to the user N as a question (Step S109). If the CPU 11 determines that the word M has been given to the user N as a question (Step S109; YES), the CPU 11 refers to the test history DB 135 and determines whether the user N has correctly answered the question of the word M (Step S115). If the CPU 11 determines that the user N has correctly answered the question of the word M (Step S115; YES), the CPU 11 determines that the word M is not a deriving target question and sets the correct answer probability of the user N for the word M to “null” (Step S111).

If the CPU 11 determines in Step S115 that the user N has incorrectly answered the question of the word M (Step S115; NO), or determines in Step S109 that the word M has not been given to the user N (Step S109; NO), the CPU 11 determines that the word M is a deriving target question and calculates the correct answer rate of the similar users for the word M as the correct answer probability of the user N for the word M (Step S110).

After Step S110 or Step S111, the CPU 11 registers the calculation result (which includes “null”) of the correct answer probability in the learning history DB 134 (Step S112a). As described above, the calculation result of the correct answer probability may be registered in the correct answer probability DB 136.

The subsequent processes (steps) are the same as those of the flowchart shown in FIG. 13.

The flowchart of the test process in this modification is basically the same as the flowchart of the test process in the above embodiment shown in FIG. 14.

However, on the difficulty specifying screen 50 displayed in Step S201 in FIG. 14, a proportion of not-yet-given questions and a proportion of incorrectly-answered questions may be specified and received.

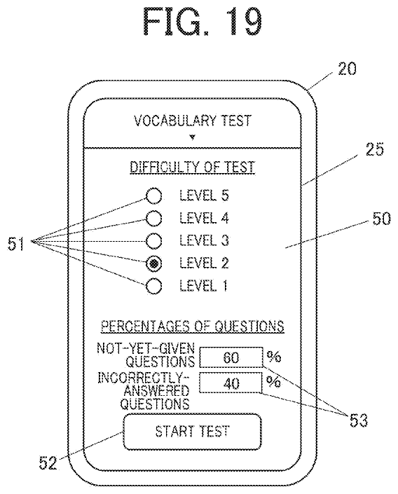

FIG. 19 shows an example of the difficulty specifying screen 50 according to the second modification.

The difficulty specifying screen 50 shown in FIG. 19 is the same as that shown in FIG. 8 except that text boxes 53 for specifying percentages of not-yet-given questions and incorrectly-answered questions are added. Selecting the test start button 52 with numerical values of any of “0” to “100” input in the text boxes 53 gives questions to the user such that the number of not-yet-given questions and the number of incorrectly-answered questions account for their respective specified percentages. If a numerical value is input in one of the two text boxes 53, which are for not-yet-given questions and for incorrectly-answered questions, a numerical value may be automatically input in the other text box 53 such that the sum of the numerical values in the two text boxes 53 becomes “100”.

The difficulty specifying screen 50 may be provided with difficulty specifying buttons 51 for not-yet-given questions and difficulty specifying buttons 51 for incorrectly-answered questions separately so that the CPU 11 can receive a first difficulty level for not-yet-given questions and a second difficulty level for incorrectly-answer questions, respectively. In this case, on the basis of the correct answer probabilities for not-yet-given questions and the correct answer probabilities for incorrectly-answered questions, the CPU 11 determines not-yet-given questions for the specified first difficulty level and incorrectly-answered questions for the specified second difficulty level as questions to be given to the target user (test words).

In this modification, both not-yet-given questions and incorrectly-answered questions are eligible as test words. However, this is not a limitation, and only incorrectly-answered questions may be eligible as word tests. In this case, only incorrectly-answered questions are set as deriving target questions, and the correct answer probabilities are calculated for incorrectly-answered questions only.

### Advantageous Effects

As described above, the server 10 as the information processing apparatus according to the embodiment includes the CPU 11. The CPU 11, based on the test history DB 135 (question-giving history information) on a plurality of questions, identifies, among users, a similar user(s) who is similar to the target user among the users in proficiency tendency of the plurality of questions, wherein the question-giving history information includes the correctness determination results of determination as to whether the users have correctly answered given questions that have been given to the users, derives the correct answer probability of the target user correctly answering a question as a deriving target question among the plurality of questions, based on the correctness determination result of determination as to whether the similar user has correctly answered the deriving target question, wherein the deriving target question is a question for which the correct answer probability is derived, and is a given question for the similar user, and performs the specific process based on the derived correct answer probability. Preferably, the test history DB 135 further includes the information on whether each of the plurality of questions has been given to each of the users, and the CPU 11 sets, among the plurality of questions, at least one (type) of a not-yet-given question(s) that has not been given to the target user and an incorrectly-answered question(s) that the target user has incorrectly answered, as the deriving target question(s). Preferably, the CPU 11 performs, as the specific process, a process of determining, based on the derived correct answer probability, a question to be given to the target user among the plurality of questions.

Thus, as compared with the conventional technique of deriving the correct answer probability of the target user for a not-yet-given question to the target user from the analysis result about his/her understanding of concepts or the like included in given question(s) to him/her, the technique of the present disclosure using the correctness determination result of the similar user's answer can easily derive the correct answer probability of the target user for the deriving target question (not-yet-given question and/or incorrectly-answered question) with high accuracy, and hence, on the basis of the derived correct answer probability, can easily give the target user a question(s) for a difficulty level appropriate for his/her learning level. For example, in the case of a word test, it is possible to predict and set, on the word test, a word(s) that the target user is unlikely to remember, and hence can efficiently improve his/her academic ability. Further, giving the target user a question(s) having a low correct answer probability allows the target user to practice and learn the question that the similar user, who is similar to the target user in learning level, has incorrectly answered, so that the target user can gain an advantage over another user(s) who is a competitor(s).

Further, since the academic ability of the target user at a point in time is reflected in selection of the similar user, the correct answer probability of the target user for the incorrectly-answered question, which the target user has incorrectly answered in the past, can be derived with the improvement of the academic ability of the target user reflected in selection of the similar user. Hence, it is possible to timely give the target user the incorrectly-answered question again in accordance with the correct answer probability, so that the target user can effectively learn the incorrectly-answered question.

Still further, since the similar user is identified and then the correct answer probability of the target user for a question is derived on the basis of the correctness determination result of the similar user's answer thereto, it is unnecessary to analyze contents of the question in order to derive the correct answer probability of the target user therefor. Hence, the technique of the present disclosure is applicable to any type of question.

Preferably, the CPU 11 identifies similar users to the target user, and treats the average of the correctness determination results of determination as to whether the similar users have correctly answered the deriving target question, as the correct answer probability of the target user for the deriving target question. This can enhance the accuracy of the correct answer probability of the target user.

Preferably, the CPU 11 identifies the similar user(s) using a cosine similarity derived based on a vector of the target user including, as elements, the correctness determination results of determination as to whether the target user has correctly answered the given questions and a vector of each of the users except the target user including, as elements, the correctness determination results of determination as to whether each of the users except the target user has correctly answered the given questions. Thus, it is possible to identify the similar user(s) by such a simple technique using the correctness determination results of each user's answers to the given questions.

Preferably, the CPU 11 identifies, among the users except the target user, a user(s) having the cosine similarity to the target user of a reference value or greater as the similar user(s). This can identify the similar user(s) whose similarity in proficiency tendency to the target user is a certain level or higher/greater.

Preferably, the CPU 11 identifies, among the users except the target user, a reference number or a reference proportion of users selected in descending order of the cosine similarity as the similar user(s). This can identify a certain number of similar users whose similarity in proficiency tendency to the target user is great.

Preferably, the CPU 11 identifies the similar user(s) based on the test history DB 135 (question-giving history information) and the user management DB 132 (feature information) including at least one (type) of an attribute(s) and a characteristic(s) of each of the users. This can identify the similar user(s) more appropriately and further enhance the accuracy of the correct answer probability of the target user.

Preferably, the CPU 11 receives a difficulty level for the question to be given to the target user, and performs the process of determining, based on the correct answer probabilities of the target user correctly answering questions as the deriving target question(s), the correct answer probabilities each being the derived correct answer probability, a question(s) having a correct answer probability(ies) corresponding to the difficulty level as the question to be given to the target user. This can give the target user a question(s) for a difficulty level appropriate for the learning level of the target user and the specified difficulty level.

Preferably, in the second modification, in response to setting the incorrectly-answered question as the deriving target question, the CPU 11 treats the average of the correctness determination results of determination as to whether the similar user(s) and the target user have correctly answered the incorrectly-answered question, as the correct answer probability of the target user for the incorrectly-answered question. It can be said that the incorrectly-answered question is a question that the target user is likely to answer incorrectly again. Hence, use of the correct answer rate of the similar user(s) and the target user for the incorrectly-answered question instead of the correct answer rate of only the similar user(s) therefor can adjust the correct answer rate to a more reasonable one, namely, to a lower one. This can further enhance the accuracy of the correct answer probability of the target user.

Preferably, in the second modification, the CPU 11 receives a proportion of the not-yet-given question(s) and a proportion of the incorrectly-answered question(s) in the question(s) to be given to the target user, and performs the process of determining, based on the correct answer probabilities of the target user correctly answering questions as the deriving target question(s), the correct answer probabilities each being the derived correct answer probability, the question to be given to the target user such that the number of not-yet-given questions and the number of incorrectly-answered questions account for the respective proportions. This can give the target user not-yet-given questions and incorrectly-answered questions at his/her desired proportions.

In the above embodiment, on the basis of (i) the information on whether each of the plurality of questions has been given to each of the users and (ii) the correctness determination results of each user's answers to given questions, which are included in the test history DB 135 (question-giving history information), the similar user(s) who is similar to the target user in proficiency tendency of the plurality of questions is identified. Alternatively, the similar user(s) who is similar to the target user in proficiency tendency of the plurality of questions may be identified on the basis of the correctness determination results of each user's answers to given questions only.

Further, in the above embodiment, among the plurality of questions, at least one (type) of a not-yet-given question(s) to the target user and an incorrectly-answered question(s) by the target user is set as the deriving target question(s). However, for example, if a long period of time has passed since a question was (last) given to the target user and accordingly the target user's memory thereof could be foggy, the question, which is neither a not-yet-given question nor an incorrectly-answer question, may be set/selected as the deriving target question.

In these cases too, it is possible to easily derive the correct answer probability of the target user for the deriving target question with high accuracy.

Further, in the above embodiment, as the specific process based on the derived correct answer probability, the process of determining a question to be given to the target user among the plurality of questions is performed, but this is not a limitation. The specific process may be a process of controlling the target user's learning (performing control on giving or not giving a question to the target user) on the basis of the derived correct answer probability, such as a process of determining, on the basis of the average value or the lowest value of the derived correct answer probabilities of the target user, whether to give a question(s) to the target user.

The information processing method that is performed by the CPU 11 (and/or the CPU 21) as the computer of the information processing system 1 according to the embodiment, includes: based on the test history DB 135 (question-giving history information) on a plurality of questions, identifying, among users, a similar user(s) who is similar to the target user among the users in proficiency tendency of the plurality of questions, wherein the question-giving history information includes the correctness determination results of determination as to whether the users have correctly answered given questions that have been given to the users; deriving the correct answer probability of the target user correctly answering a question as a deriving target question among the plurality of questions, based on the correctness determination result of determination as to whether the similar user has correctly answered the deriving target question, wherein the deriving target question is a question for which the correct answer probability is derived, and is a given question for the similar user; and performing the specific process based on the derived correct answer probability. Preferably, the test history DB 135 further includes the information on whether each of the plurality of questions has been given to each of the users, and the information processing method further includes setting, among the plurality of questions, at least one (type) of a not-yet-given question(s) that has not been given to the target user and an incorrectly-answered question(s) that the target user has incorrectly answered, as the deriving target question(s). Preferably, the specific process is a process of determining, based on the derived correct answer probability, a question to be given to the target user among the plurality of questions.

Thus, as compared with the conventional technique of deriving the correct answer probability of the target user for a not-yet-given question to the target user from the analysis result about his/her understanding of concepts or the like included in given question(s) to him/her, the technique of the present disclosure using the correctness determination of the similar user's answer can easily derive the correct answer probability of the target user for the deriving target question (not-yet-given question and/or incorrectly-answered question) with high accuracy, and hence, on the basis of the derived correct answer probability, can easily give the target user a question(s) for a difficulty level appropriate for his/her learning level. Further, it is possible to timely give the target user the incorrectly-answered question again in accordance with the correct answer probability, which is derived with the improvement of the academic ability of the target user reflected in selection of the similar user, so that the target user can effectively learn the incorrectly-answered question. Still further, since the similar user is identified and then the correct answer probability of the target user for a question is derived on the basis of the correctness determination result of the similar user's answer thereto, it is unnecessary to analyze contents of the question in order to derive the correct answer probability of the target user therefor. Hence, the technique of the present disclosure is applicable to any type of question.

The storage 13 according to the embodiment stores the server control program 131 as a program. The server control program 131 causes the CPU 11 as the computer of the server 10 as the information processing apparatus to: based on the test history DB 135 (question-giving history information) on a plurality of questions, identify, among users, a similar user(s) who is similar to the target user among the users in proficiency tendency of the plurality of questions, wherein the question-giving history information includes the correctness determination results of determination as to whether the users have correctly answered given questions that have been given to the users; derive the correct answer probability of the target user correctly answering a question as a deriving target question among the plurality of questions, based on the correctness determination result of determination as to whether the similar user has correctly answered the deriving target question, wherein the deriving target question is a question for which the correct answer probability is derived, and is a given question for the similar user; and perform the specific process based on the derived correct answer probability. Preferably, the test history DB 135 further includes the information on whether each of the plurality of questions has been given to each of the users, and the server control program 131 further causes the CPU 11 to set, among the plurality of questions, at least one (type) of a not-yet-given question(s) that has not been given to the target user and an incorrectly-answered question(s) that the target user has incorrectly answered, as the deriving target question(s). Preferably, the specific process is a process of determining, based on the derived correct answer probability, a question to be given to the target user among the plurality of questions.

Thus, as compared with the conventional technique of deriving the correct answer probability of the target user for a not-yet-given question to the target user from the analysis result about his/her understanding of concepts or the like included in given question(s) to him/her, the technique of the present disclosure using the correctness determination result of the similar user's answer can easily derive the correct answer probability of the target user for the deriving target question (not-yet-given question and/or incorrectly-answered question) with high accuracy, and hence, on the basis of the derived correct answer probability, can easily give the target user a question(s) for a difficulty level appropriate for his/her learning level. Further, it is possible to timely give the target user the incorrectly-answered question again in accordance with the correct answer probability, which is derived with the improvement of the academic ability of the target user reflected in selection of the similar user, so that the target user can effectively learn the incorrectly-answered question. Still further, since the similar user is identified and then the correct answer probability of the target user for a question is derived on the basis of the correctness determination result of the similar user's answer thereto, it is unnecessary to analyze contents of the question in order to derive the correct answer probability of the target user therefor. Hence, the technique of the present disclosure is applicable to any type of question.

### <Others>

Those described in the above embodiment (and the modifications) are not limitations but some examples of the information processing apparatus, the information processing method and the storage medium of the present disclosure.

For example, part or all of the processes that are performed by the server 10 in the above embodiment may be performed by the terminal apparatus 20. If the CPU 21 of the terminal apparatus 20 calculates the correct answer probabilities and selects questions on the basis of the correct answer probabilities, the terminal apparatus 20 corresponds to the information processing apparatus.

Further, in the above embodiment, the questions that are given to the user are words on a word test to which their spellings or translations should be given as answers, but not limited thereto. The questions may be any questions as far as whether user's answers thereto are correct or not can be determined. Hence, the method for setting questions (method for determining questions to be given to the user) in the above embodiment is applicable to various questions (e.g., questions requiring memory to answer, questions on a written test, questions on a listing test using the audio outputter 26 of the terminal apparatus 20, etc.) in various subjects (e.g., mathematics, language, etc.). Further, the method is applicable not only to questions in school education but also to questions on a qualifying test, such as a test at a driving school, questions at a quiz game, and so forth.

Further, in the above embodiment, the user specifies the difficulty of questions on the difficulty specifying screen 50, but this is not a limitation. The CPU 11 of the server 10 may extract questions in accordance with a preset difficulty level/degree. For example, the CPU 11 may extract words that are assumed to have a high possibility that the user does not remember (words each having a correct answer probability of a predetermined value or less), or conversely, may extract words that are assumed to have a high possibility that the user remembers (words each having a correct answer probability of a predetermined value or greater) in order to confirm user's understanding. In these cases, display of the difficulty specifying screen 50 is omitted.

Further, in the above embodiment, the HDD or the SSD of the storage 13 is used as the computer-readable storage medium storing the program(s) of the present disclosure, but this is not a limitation. The computer-readable storage medium may be an information recording medium, such as a flash memory or a CD-ROM. Further, as a medium to provide data of the program(s) of the present disclosure via a communication line, a carrier wave may be used.

As a matter of course, the detailed configuration and operation of each component of the server 10 and the terminal apparatus(es) 20 constituting the learning support system 1 can be appropriately modified without departing from the scope of the present disclosure.

What is claimed is:

1. An information processing apparatus comprising at least one processor configured to
based on question-giving history information on a plurality of questions, identify, among users, a similar user who is similar to a target user among the users in proficiency tendency of the plurality of questions, wherein the question-giving history information includes correctness determination results of determination as to whether the users have correctly answered given questions that have been given to the users,
derive a correct answer probability of the target user correctly answering a question as a deriving target question among the plurality of questions, based on a correctness determination result of determination as to whether the similar user has correctly answered the deriving target question, wherein the deriving target question is a question for which the correct answer probability is derived, and is a given question for the similar user, and
perform a specific process based on the derived correct answer probability.

2. The information processing apparatus according to claim 1,
wherein the question-giving history information further includes information on whether each of the plurality of questions has been given to each of the users, and
wherein the processor is configured to set, among the plurality of questions, at least one of a not-yet-given question that has not been given to the target user and an incorrectly-answered question that the target user has incorrectly answered, as the deriving target question.

3. The information processing apparatus according to claim 1, wherein the processor is configured to perform, as the specific process, a process of determining, based on the derived correct answer probability, a question to be given to the target user among the plurality of questions.

4. The information processing apparatus according to claim 1, wherein the processor is configured to perform, as the specific process, a process of performing, based on the derived correct answer probability, control on giving or not giving a question to the target user.

5. The information processing apparatus according to claim 1, wherein the processor is configured to
identify similar users as the similar user, and
treat an average of correctness determination results of determination as to whether the similar users have correctly answered the deriving target question, as the correct answer probability of the target user for the deriving target question.

6. The information processing apparatus according to claim 1, wherein the processor is configured to identify the similar user using a cosine similarity derived based on a vector of the target user including, as elements, correctness determination results of determination as to whether the target user has correctly answered the given questions and a vector of each of the users except the target user including, as elements, correctness determination results of determination as to whether each of the users except the target user has correctly answered the given questions.

7. The information processing apparatus according to claim 6, wherein the processor is configured to identify, among the users except the target user, a user having the cosine similarity to the target user of a reference value or greater as the similar user.

8. The information processing apparatus according to claim 6, wherein the processor is configured to identify, among the users except the target user, a reference number or a reference proportion of users selected in descending order of the cosine similarity as the similar user.

9. The information processing apparatus according to claim 1, wherein the processor is configured to identify the similar user based on the question-giving history information and feature information including at least one of an attribute and a characteristic of each of the users.

10. The information processing apparatus according to claim 3, wherein the processor is configured to
receive a difficulty level for the question to be given to the target user, and
perform the process of determining, based on correct answer probabilities of the target user correctly answering questions as the deriving target question, the correct answer probabilities each being the derived correct answer probability, a question having a correct answer probability corresponding to the difficulty level as the question to be given to the target user.

11. The information processing apparatus according to claim 2, wherein the processor is configured to, in response to setting the incorrectly-answered question as the deriving target question, treat an average of correctness determination results of determination as to whether the similar user and the target user have correctly answered the incorrectly-answered question, as the correct answer probability of the target user for the incorrectly-answered question.

12. The information processing apparatus according to claim 3,
wherein the question-giving history information further includes information on whether each of the plurality of questions has been given to each of the users, and
wherein the processor is configured to
set, among the plurality of questions, at least one of a not-yet-given question that has not been given to the target user and an incorrectly-answered question that the target user has incorrectly answered, as the deriving target question,
receive a proportion of the not-yet-given question and a proportion of the incorrectly-answered question in the question to be given to the target user, and
perform the process of determining, based on correct answer probabilities of the target user correctly answering questions as the deriving target question, the correct answer probabilities each being the derived correct answer probability, the question to be given to the target user such that the number of not-yet-given questions and the number of incorrectly-answered questions account for the respective proportions.

13. An information processing method that is performed by a computer of an information processing system, comprising:
based on question-giving history information on a plurality of questions, identifying, among users, a similar user who is similar to a target user among the users in proficiency tendency of the plurality of questions, wherein the question-giving history information includes correctness determination results of determination as to whether the users have correctly answered given questions that have been given to the users;
deriving a correct answer probability of the target user correctly answering a question as a deriving target question among the plurality of questions, based on a correctness determination result of determination as to whether the similar user has correctly answered the deriving target question, wherein the deriving target question is a question for which the correct answer probability is derived, and is a given question for the similar user; and
performing a specific process based on the derived correct answer probability.

14. The information processing method according to claim 13,
wherein the question-giving history information further includes information on whether each of the plurality of questions has been given to each of the users, and
wherein the information processing method further comprises setting, among the plurality of questions, at least one of a not-yet-given question that has not been given to the target user and an incorrectly-answered question that the target user has incorrectly answered, as the deriving target question.

15. The information processing method according to claim 13, wherein the specific process is a process of determining, based on the derived correct answer probability, a question to be given to the target user among the plurality of questions.

16. The information processing method according to claim 13, wherein the specific process is a process of performing, based on the derived correct answer probability, control on giving or not giving a question to the target user.

17. A non-transitory computer-readable storage medium storing a program that causes a computer of an information processing apparatus to:
based on question-giving history information on a plurality of questions, identify, among users, a similar user who is similar to a target user among the users in proficiency tendency of the plurality of questions, wherein the question-giving history information includes correctness determination results of determination as to whether the users have correctly answered given questions that have been given to the users;
derive a correct answer probability of the target user correctly answering a question as a deriving target question among the plurality of questions, based on a correctness determination result of determination as to whether the similar user has correctly answered the deriving target question, wherein the deriving target question is a question for which the correct answer probability is derived, and is a given question for the similar user; and
perform a specific process based on the derived correct answer probability.

18. The non-transitory computer-readable storage medium according to claim 17,
wherein the question-giving history information further includes information on whether each of the plurality of questions has been given to each of the users, and
wherein the program further causes the computer to set, among the plurality of questions, at least one of a not-yet-given question that has not been given to the target user and an incorrectly-answered question that the target user has incorrectly answered, as the deriving target question.

19. The non-transitory computer-readable storage medium according to claim 17, wherein the specific process is a process of determining, based on the derived correct answer probability, a question to be given to the target user among the plurality of questions.

20. The non-transitory computer-readable storage medium according to claim 17, wherein the specific process is a process of performing, based on the derived correct answer probability, control on giving or not giving a question to the target user.
